(19) United States
(12) Patent Application Publication
(10) Pub. No.: US 2016/0358561 A1
(43) Pub. Date: Dec. 8, 2016

(54) BACKLIGHT UNIT, METHOD FOR DRIVING THE BACKLIGHT UNIT, AND LIQUID CRYSTAL DISPLAY

(71) Applicant: SHENZHEN CHINA STAR OPTOELECTRONICS TECHNOLOGY CO., LTD., Shenzhen, Guangdong (CN)

(72) Inventors: Xinhong CHEN, Shenzhen, Guangdong (CN); Yu-yeh CHEN, Shenzhen, Guangdong (CN); Yuhua CHANG, Shenzhen, Guangdong (CN)

(73) Assignee: Shenzhen China Star Optoelectronics Technology Co., Ltd., Shenzhen, Guangdong (CN)

(21) Appl. No.: 14/422,663

(22) PCT Filed: Jan. 7, 2015
(86) PCT No.: PCT/CN2015/070306

§ 371 Date: Feb. 19, 2015

(30) Foreign Application Priority Data
Nov. 10, 2014 (CN) 201410627553.X

(51) Int. Cl. G09G 3/36

(52) U.S. Cl. CPC G09G 3/36; G09G 2310/0237

(57) ABSTRACT

The present invention discloses a backlight unit, including a backlight module including a light source for emitting light; a voltage generating unit for providing a driving voltage to the backlight unit; a backlight controlling unit for receiving a frame frequency signal and producing a cycle controlling signal having a same cycle time to the frame frequency signal; a backlight driving chip for producing a PWM signal according to the cycle controlling signal and a preset duty ratio D, wherein the PWM signal has a same cycle time to the cycle controlling time, and the duty ratio of the PWM signal is D in each cycle, the PWM signal being configured for controlling the voltage generating unit to provide or cut off the driving voltage to the backlight unit. The present invention also provides a method for driving the above backlight unit and a liquid crystal display including the backlight unit.

### TECHNICAL FIELD

The present invention relates to liquid crystal displays, and more particularly relates to a backlight unit, a driving method of the backlight unit and a liquid crystal display including the backlight unit.

### BACKGROUND

Liquid crystal displays (LCDs) are flat and ultra-thin display devices, which are consisting of a number of color or black-white pixels disposed in front of a light source or a reflective surface. LCDs have features such as low power consumption, high display quality, low volume, and low eight, and thus are liked by most people and become mainstream display devices. A liquid crystal display usually includes a LCD panel and a backlight unit. The LCD panel and the backlight unit are disposed opposite to each other. The backlight unit provides light source to the LCD panel and the LCD panel uses the light source to display images.

In some existing LCDs, the backlight unit is driven by a driving signal that is synchronous with a frame frequency signal Vsync. FIG. 1 illustrates a waveform of a driving signal, the frequency of the frame frequency signal is 100 Hz and the cycle time is 10 ms. When a driving signal PWM of the backlight module is synchronized to the frame frequency signal, the duty ratio of the time that the backlight unit is switched is the same. By optimizing the duty ratio the brightness of the LCD is controlled thereby improving the display quality and saving the power consumed.

According to the above controlling manner, the duty ratio is a preset fixed value assuming that the frequency of the frame frequency signal doesn't change. However, under some circumstance, for example, when the channel is switched, a 2D/3D mode is switched or a signal source is switched, the frequency of the frame frequency signal will vary. For example, FIG. 2 illustrates a waveform of a driving signal. The frame frequency signal is normal in the 1^{st} frame F1, the frequency is 100 Hz, the cycle time is 10 ms. In the 2^{nd} frame F2, the situation changes, the frequency is 137 Hz and the cycle time is 7.3 ms. The frequency of the 3^{rd} frame F3 is 116 Hz and the cycle time is 8.6 ms. The frequency of the 4^{th} and 5^{th} frames is 137 Hz and the cycle time is 7.3 ms. The frequency of the 6^{th} and 7^{th} frames changes back to the normal values, that is, the frequency is 100 Hz and the cycle time is 10 ms. At the beginning of F2, the backlight unit is switched on, since the driving signal PWM of the backlight unit is set without considering the variation of the frame frequency signal, one cycle of the driving signal PWM continues until F3 starts. For F2, overflow of the backlight unit occurs. For F3, the light sourced provided by the backlight unit is insufficient. The same situation occurs between F4 and F5, and returns to the normal stat until F6 and F7. As described above, according to the synchronizing manner of the driving signal and the frame frequency signal in the existing backlight units, the duty ratio of the backlight unit is switched is different with a preset value in a frame cycle in which the frame frequency signal suddenly changes, and thus decreases the display quality of LCDs.

### SUMMARY

To overcome the shortcomings of the existing art, the present invention provides a backlight unit and a method of driving the backlight unit, a driving signal of the backlight unit is synchronous with the frame frequency signal, and the driving signal also varies when the frame frequency signal suddenly changes. In each frame, the duty ratio of on time of the backlight unit is consistent with a preset duty ratio, and thus the display quality is ensured.

To achieve the above object, an embodiment of the present invention provides a backlight unit.

The backlight unit includes a backlight module including a light source for emitting light, a voltage generating unit for providing a driving voltage to the backlight unit, a backlight controlling unit for receiving a frame frequency signal and producing a cycle controlling signal according to the frame frequency signal, wherein the cycle controlling signal has a same cycle time to the frame frequency signal, a backlight driving chip for producing a pulse width modulating (PWM) signal according to the cycle controlling signal and a preset duty ratio D, wherein the PWM signal has a same cycle time to the cycle controlling time, and the duty ratio of the PWM signal is D in each cycle, the PWM signal is configured for controlling the voltage generating unit to provide or cut off the driving voltage to the backlight unit.

In one embodiment, the backlight controlling unit includes a micro control unit (MCU) chip, and the MCU chip receives the frame frequency signal and provides the cycle controlling signal.

In one embodiment, the MCU chip captures a rising edge of a current frame frequency signal, ascertains a cycle time of the current frame frequency signal, and produced a real-time cycle controlling signal according to the cycle time of the current frame frequency signal. The cycle time of the current frame frequency signal is same to that of the current frame frequency signal.

In one embodiment, the backlight module further includes a reflective plate, a light guide plate and an optical film group stacked together. The light source is disposed opposite to the light guide plate, and the light emitted from the light source is transmitted to the light guide plate.

In one embodiment, the light source includes a light emitting diode (LED) assembly including a number of LEDs.

Another embodiment of the present invention also provides a method for driving a backlight unit. The backlight unit includes a backlight module having a light source and a voltage generating unit for providing a driving voltage to the backlight module. The method includes the following steps.

A backlight controlling unit receives a frame frequency signal and produces a cycle controlling signal according to the frame frequency signal, wherein the cycle controlling signal has a same cycle time to the frame frequency signal.

A backlight driving chip produces a pulse width modulating (PWM) signal according to the cycle controlling signal and a preset duty ratio D, wherein the PWM signal has a same cycle time to the cycle controlling time, and the duty ratio of the PWM signal is D in each cycle, the PWM signal is configured for controlling the voltage generating unit to provide or cut off the driving voltage to the backlight unit.

In one embodiment, the backlight controlling unit includes a micro control unit (MCU) chip, and the MCU chip receives the frame frequency signal and provides the cycle controlling signal.

In one embodiment, the MCU chip captures a rising edge of a current frame frequency signal, ascertains a cycle time of the current frame frequency signal, and produced a real-time cycle controlling signal according to the cycle time of the current frame frequency signal. The cycle time of the current frame frequency signal is same to that of the current frame frequency signal.

In one embodiment, the backlight module further includes a reflective plate, a light guide plate and an optical film group stacked together. The light source is disposed opposite to the light guide plate, and the light emitted from the light source is transmitted to the light guide plate.

Another embodiment of the present invention also provides a liquid crystal display, which includes a liquid crystal display panel including a number of pixel units, a source driver for providing data signals to the pixel units, a gate driver for providing scanning signals to the pixel units, a backlight unit for providing light source to the LCD panel, and a timing controller for receiving image data and producing a controlling signal for controlling the source drive and the gate driver. The timing controller also produces a frame frequency signal provided to the backlight controlling unit of the backlight unit.

According to the backlight unit and the driving method of the backlight unit provided by embodiments of the present invention, the driving signal is synchronous with the frame frequency signal, and the driving signals of the backlight unit also varies in correspondence with the variation of the frame frequency signal. Thus, the duty ratio of on time of the backlight unit is consistent with the preset duty ratio, and the display quality is ensured.

### BRIEF DESCRIPTION OF THE DRAWINGS

FIG. 1 is a schematic view showing a waveform of a driving signal of a backlight unit at a normal state of a frame frequency signal in the known art.

FIG. 2 is a schematic view showing a waveform of a driving signal of a backlight unit at an abnormal state of a frame frequency signal in the known art.

FIG. 3 is a schematic view of a liquid crystal display provided in an embodiment of the present invention.

FIG. 4 is a schematic view of a backlight unit provided in an embodiment of the present invention.

FIG. 5 is a schematic view of a backlight module provided in an embodiment of the present invention.

FIG. 6 is a schematic view showing a waveform of a driving signal of a backlight unit at an abnormal state of a frame frequency signal in the known art.

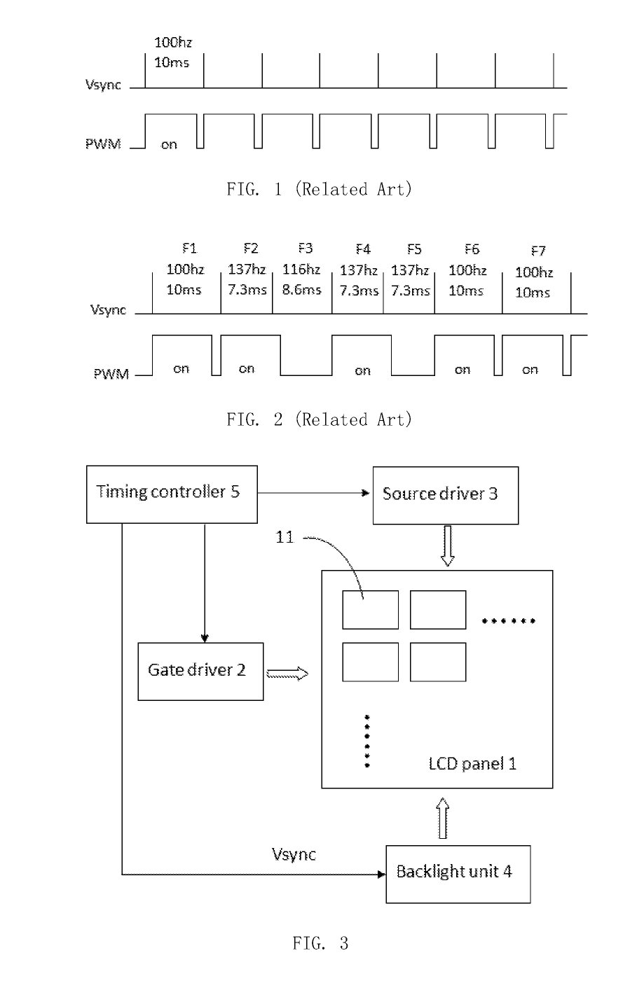

### DETAILED DESCRIPTION OF PREFERRED EMBODIMENTS

To make the object, technical details and advantages of the present invention more can be clearly understood, embodiments of the present invention are described accompanying with figures as follows.

As shown in FIG. 3, one embodiment provides a liquid crystal display, which includes a LCD panel 1 including a number of pixel units, a gate driver 2, a source driver 3, a backlight unit 4 and a timing controller 5.

The timing controller 5 receives image data and produces a controlling signal for controlling the source driver 3 and the gate driver 2. The timing controller 5 controls the gate driver 2 to provide scanning signals to the pixel units 11. In addition, the timing controller 5 also produces a frame frequency signal V_{sync} for the backlight unit 4. The backlight unit 4 is driven by the frame frequency signal V_{sync} to provide light source for the LCD panel 1, and then the LCD panel display images.

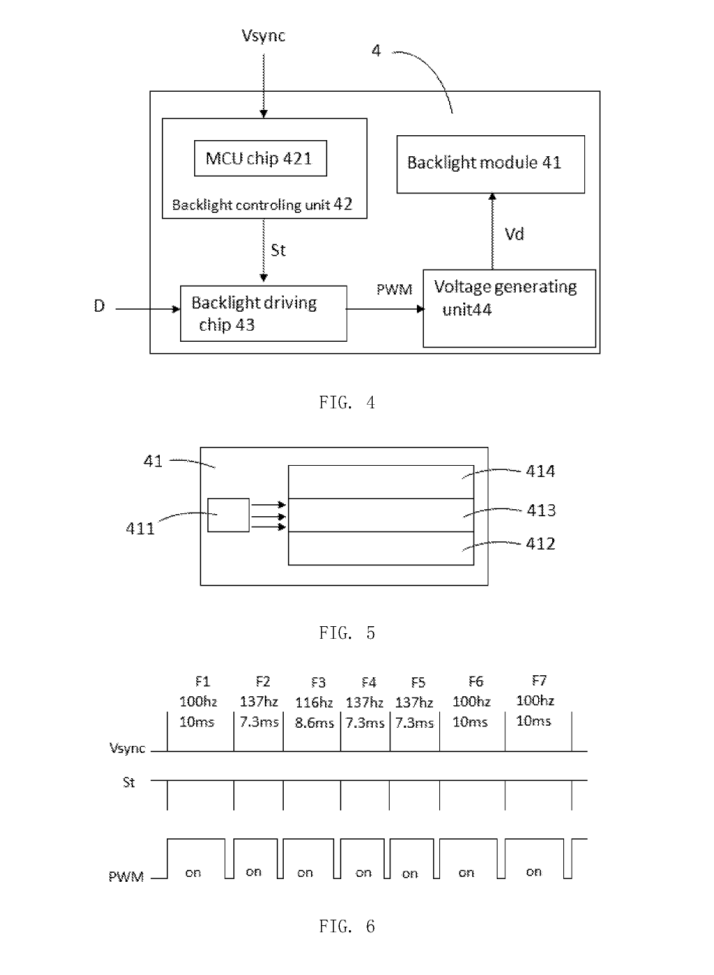

Referring to FIGS. 4 and 5, the backlight unit 4 of the present embodiment includes a backlight module 41, a backlight controlling unit 42, a backlight driving chip 43 and a voltage generating unit 44. The backlight 41 includes a light source 411 for emitting light. The voltage generating unit 44 is configured for providing a driving voltage to the backlight module 41. The backlight controlling unit 42 receives the frame frequency signal V_{sync}, and produces a cycle controlling signal St according to the frame frequency signal V_{sync}. The cycle controlling signal St has a same cycle time to the frame frequency signal V_{sync}. The backlight driving chip 43 produces a pulse width modulating (PWM) signal according to the cycle controlling signal St and a preset duty ratio D. The PWM signal has a same cycle time to the cycle controlling signal St, and the duty ratio of the PWM signal is kept at D in each cycle time. The PWM signal is configured for controlling the voltage generating unit to provide or cut off a driving voltage V_{d} to the backlight unit 41.

Further, the backlight controlling unit 42 includes a micro control unit (MCU) chip 421. The MCU chip 421 receives the frame frequency signal V_{sync} and produces the cycle controlling signal St. Specifically, the MCU chip 421 captures a rising edge of the current frame frequency signal V_{sync}, ascertains the cycle time of the current frame frequency signal V_{sync}, and produces a real-time cycle controlling signal St according to the cycle time of the current frame frequency signal V_{sync}. The cycle time of the real-time cycle controlling signal St is same to that of the current frame frequency signal V_{sync}.

As shown in FIG. 5, in the present embodiment, the backlight module 41 further includes a reflective plate 412, a light guide plate 413 and an optical film group 414 stacked together. The light source 411 is disposed opposite to the light guide plate 412, the light emitted by the light source 411 is transmitted to the light guide plate 413. In detail, the light source 411 may be a LED assembly includes a number of LEDs.

The backlight unit 4, for example, is driven by the following manner.

Firstly, the backlight controlling unit 42 receives the frame frequency signal V_{sync} sent from the timing controller 5 and produces the cycle controlling signal St according to the frame frequency signal V_{sync}. In detail, the MCU chip 421 in the backlight controlling unit 42 receives the frame frequency signal V_{sync} and produces the cycle controlling signal St. In further detail, the MCU chip 421 captures a rising edge of the current frame frequency signal V_{sync}, ascertains the cycle time Tᵢ of the current frame frequency signal V_{sync}, and produces a real-time cycle controlling signal St according to the cycle time Tᵢ of the current frame frequency signal V_{sync}. The cycle time of the real-time cycle controlling signal St is Tm, wherein Tₘ=Tᵢ.

Then, the backlight driving chip 43 produces a PWM signal according to the cycle controlling signal St and a preset duty ratio D. The PWM signal has a cycle time of Tₙ, wherein Tₙ=Tₘ. In addition, the duty ratio of the PWM signal is kept at D in each cycle time.

Finally, the PWM signal controls the voltage generating unit 44 provides or cuts off the driving voltage provided to the backlight module 41, thereby controlling the on time duty ratio of the backlight module 41 to the preset duty ratio D.

According to the above driving manner, if the cycle time Tᵢ of the current frame frequency signal changes relative to the previous cycle, the cycle time Tm of the corresponding real-time cycle controlling signal St varies correspondingly, and the cycle time Tₙ of the PWM signal of the current frame also varies correspondingly. That is, for any frame of images, a relation Tₙ=Tₘ=Tᵢ is kept. Since the PWM signal is directly synchronized to the cycle controlling signal St, and the cycle controlling signal St also varies according to the frame frequency signal V_{sync}, therefor, the PWM signal can also controls the on time duty ratio of the backlight module 41 is kept as the preset value D when the frame frequency signal V_{sync} suddenly changes.

In a specific example, as shown by the waveform in FIG. 6, the frame frequency signal V_{sync} is normal in the 1^{st} frame F1, which has a frequency of 100 Hz and a cycle time of 10 ms. In the 2^{nd} frame F2, the frequency changes to 137 Hz and the cycle time changes to 7.3 ms. The frequency of the 3^{rd} frame F3 is 116 Hz and the cycle time is 8.6 ms. The frequency of the 4^{th} and 5^{th} frames is 137 Hz and the cycle time is 7.3 ms. The frequency of the 6^{th} and 7^{th} frames changes back to the normal values, that is, the frequency is 100 Hz and the cycle time is 10 ms. The frame frequency signal V_{sync} is abnormal in the 2nd-5th frames, and the cycle time Tᵢ thereof are 7.3 ms, 8.6 ms, 7.3 ms and 7.3 ms, respectively. Accordingly, the cycle time Tm of the corresponding cycle controlling signal St and the cycle time Tₙ of the PWM signal also varies to 7.3 ms, 8.6 ms, 7.3 ms and 7.3 ms, respectively. According to the preset duty ratio D, the on time of the backlight module 41 is controlled. As a sequence, the on time duty ratio of the backlight module 41 is kept at D in the abnormal frames of the frame frequency signals V_{sync}.

In summary, according to the backlight unit and the driving method of the backlight unit provided by embodiments of the present invention, the driving signal is synchronous with the frame frequency signal, and the driving signals of the backlight unit also varies in correspondence with the variation of the frame frequency signal. Thus, the duty ratio of on time of the backlight unit is consistent with the preset duty ratio, and the display quality is ensured.

The above descriptions are only embodiments of the present invention. It is to be noted that modifications or improvements can also be made by those ordinarily skilled in the art without out of the spirit of the present invention, and these modifications and improvements should also be included in the scope of the present invention.

What is claimed is:

1. A backlight unit, comprising:
a backlight module including a light source for emitting light;
a voltage generating unit for providing a driving voltage to the backlight unit;
a backlight controlling unit for receiving a frame frequency signal and producing a cycle controlling signal according to the frame frequency signal, wherein the cycle controlling signal has a same cycle time to the frame frequency signal;
a backlight driving chip for producing a pulse width modulating (PWM) signal according to the cycle controlling signal and a preset duty ratio D, wherein the PWM signal has a same cycle time to the cycle controlling time, and the duty ratio of the PWM signal is D in each cycle, the PWM signal being configured for controlling the voltage generating unit to provide or cut off the driving voltage to the backlight unit.

2. The backlight unit of claim 1, wherein backlight controlling unit comprises a micro control unit (MCU) chip, and the MCU chip receives the frame frequency signal and provides the cycle controlling signal.

3. The backlight unit of claim 1, wherein the MCU chip captures a rising edge of a current frame frequency signal, ascertains a cycle time of the current frame frequency signal, and produced a real-time cycle controlling signal according to the cycle time of the current frame frequency signal, the cycle time of the current frame frequency signal being same to that of the current frame frequency signal.

4. The backlight unit of claim 1, wherein the backlight module further comprises a reflective plate, a light guide plate and an optical film group stacked together, the light source being disposed opposite to the light guide plate, the light emitted from the light source being transmitted to the light guide plate.

5. The backlight unit of claim 4, wherein the light source includes a light emitting diode (LED) assembly including a number of LEDs.

6. The backlight unit of claim 3, wherein the backlight module further comprises a reflective plate, a light guide plate and an optical film group stacked together, the light source being disposed opposite to the light guide plate, the light emitted from the light source being transmitted to the light guide plate.

7. A method for driving a backlight unit, the backlight unit comprising a backlight module having a light source and a voltage generating unit for providing a driving voltage to the backlight module, the method comprising:
a backlight controlling unit receiving a frame frequency signal and produces a cycle controlling signal according to the frame frequency signal, wherein the cycle controlling signal has a same cycle time to the frame frequency signal.
backlight driving chip producing a pulse width modulating (PWM) signal according to the cycle controlling signal and a preset duty ratio D, wherein the PWM signal has a same cycle time to the cycle controlling time, and the duty ratio of the PWM signal is D in each cycle, the PWM signal being configured for controlling the voltage generating unit to provide or cut off the driving voltage to the backlight unit.

8. The method of claim 7, wherein the backlight controlling unit includes a micro control unit (MCU) chip, and the MCU chip receives the frame frequency signal and provides the cycle controlling signal.

9. The method of claim 8, wherein the MCU chip captures a rising edge of a current frame frequency signal, ascertains a cycle time of the current frame frequency signal, and produced a real-time cycle controlling signal according to the cycle time of the current frame frequency signal, the cycle time of the current frame frequency signal being same to that of the current frame frequency signal.

10. The method of claim 7, wherein the backlight module further comprises a reflective plate, a light guide plate and an optical film group stacked together, the light source being disposed opposite to the light guide plate, and the light emitted from the light source being transmitted to the light guide plate.

11. The method of claim 7, wherein the light source includes a light emitting diode (LED) assembly including a number of LEDs.

12. The method of claim 9 wherein the MCU chip captures a rising edge of a current frame frequency signal, ascertains a cycle time of the current frame frequency signal, and produced a real-time cycle controlling signal according to the cycle time of the current frame frequency signal, the cycle time of the current frame frequency signal being same to that of the current frame frequency signal.

13. A liquid crystal display, comprising:
a liquid crystal display panel comprising a number of pixel units,
a source driver for providing data signals to the pixel units,
a gate driver for providing scanning signals to the pixel units,
a backlight unit for providing light source to the LCD panel, and
a timing controller for receiving image data and producing a controlling signal for controlling the source drive and the gate driver, the timing controller also producing a frame frequency signal provided to the backlight controlling unit of the backlight unit;
the backlight unit comprising:
a backlight module, comprising a light source for emitting light;
a voltage generating unit, for providing a driving voltage to the backlight module;
a backlight controlling unit for receiving a frame frequency signal and produces a cycle controlling signal according to the frame frequency signal, wherein the cycle controlling signal has a same cycle time to the frame frequency signal;
a backlight driving chip for producing a pulse width modulating (PWM) signal according to the cycle controlling signal and a preset duty ratio D, wherein the PWM signal has a same cycle time to the cycle controlling time, and the duty ratio of the PWM signal is D in each cycle, the PWM signal being configured for controlling the voltage generating unit to provide or cut off the driving voltage to the backlight unit.

14. The liquid crystal display of claim 13, wherein the backlight controlling unit includes a micro control unit (MCU) chip, and the MCU chip receives the frame frequency signal and provides the cycle controlling signal.

15. The liquid crystal display of claim 14, wherein the MCU chip captures a rising edge of a current frame frequency signal, ascertains a cycle time of the current frame frequency signal, and produced a real-time cycle controlling signal according to the cycle time of the current frame frequency signal, the cycle time of the current frame frequency signal being same to that of the current frame frequency signal.

16. The liquid crystal display of claim 13, wherein the backlight module further comprises a reflective plate, a light guide plate and an optical film group stacked together, the light source being disposed opposite to the light guide plate, and the light emitted from the light source being transmitted to the light guide plate.

17. The liquid crystal display of claim 16, wherein the light source includes a light emitting diode (LED) assembly including a number of LEDs.

18. The liquid crystal display of claim 15 wherein the MCU chip captures a rising edge of a current frame frequency signal, ascertains a cycle time of the current frame frequency signal, and produced a real-time cycle controlling signal according to the cycle time of the current frame frequency signal, the cycle time of the current frame frequency signal being same to that of the current frame frequency signal.
